(19) United States
(12) Patent Application Publication
(10) Pub. No.: US 2014/0278857 A1
(43) Pub. Date: Sep. 18, 2014

(54) Systems and Methods for Management of Consumer Incentives

(71) Applicant: Cardeeo, Inc., Pittsburgh, PA (US)

(72) Inventor: Brock Bergman, Seven Fields, PA (US)

(73) Assignee: Cardeeo, Inc., Pittsburgh, PA (US)

(21) Appl. No.: 14/186,767

(22) Filed: Feb. 21, 2014

Related U.S. Application Data
(60) Provisional application No. 61/788,488, filed on Mar. 15, 2013.

(51) Int. Cl. G06Q 30/02

(52) U.S. Cl. CPC G06Q 30/0211; G06Q 30/0226
USPC 705/14.13

(57) ABSTRACT

Systems and methods are provided for tracking effectiveness of incentives transmitted to particular consumers. A computer-readable medium is configured to store a consumer profile data structure configured to store consumer data including consumer history data and an incentives offered data structure configured to store a history of incentives offered including an identification of to which consumers a particular incentive was offered and which of those consumers redeemed the particular incentive. One or more data processors configured to access the one or more computer-readable mediums and to execute steps including updating the consumer profile data structure based on consumer activity data associated with the particular consumer; transmitting the particular incentive to the particular consumer based on consumer data associated with the particular consumer; and updating the consumer profile data structure and the incentives offered data structure based on receipt of an indication that the particular consumer redeemed the particular incentive.

### CROSS-REFERENCE TO RELATED APPLICATIONS

The present application claims priority from U.S. Provisional Application Ser. No. 61/788,488 entitled “Usage of Intelligent Bar Codes and Near-Field Communication Devices for Customer Loyalty Program and Advertising Network on Mobile Devices via Hardware-Free Point of Sale Integration,” filed 15 Mar. 2013, the entirety of which is hereby incorporated by reference.

### FIELD

This disclosure is related generally to customer loyalty tracking, in-store mobile coupon redemption tracking, and more particularly to full cycle customer activity and incentive tracking.

### BACKGROUND

Advertising campaigns are commonly used to entice certain consumer behavior, such as visiting a merchant location or purchasing a merchant product. Advertising can be an expensive endeavor, with fees charged for playing of television and radio ads; display of text, graphics, or video advertisements on the interne; and printing of advertisements in newspapers or other periodicals. It is often a challenge to track the effectiveness of advertising campaigns to determine the amount of variation in consumer activity that is attributable to such campaigns.

### SUMMARY

Systems and methods are provided for tracking effectiveness of incentives transmitted to particular consumers. A computer-readable medium is configured to store a consumer profile data structure configured to store consumer data including consumer history data and an incentives offered data structure configured to store a history of incentives offered including an identification of to which consumers a particular incentive was offered and which of those consumers redeemed the particular incentive. One or more data processors are configured to access the one or more computer-readable mediums and to execute steps including updating the consumer profile data structure based on consumer activity data associated with the particular consumer; transmitting the particular incentive to the particular consumer based on consumer data associated with the particular consumer; and updating the consumer profile data structure and the incentives offered data structure based on receipt of an indication that the particular consumer redeemed the particular incentive.

As another example, a method of tracking effectiveness of incentives transmitted to particular customers comprises steps that include maintaining a consumer profile data structure configured to store consumer data including consumer history data. An incentives offered data structure is maintained that is configured to store a history of incentives offered including an identification of to which consumers a particular incentive was offered and which of those consumers redeemed the particular incentive. The consumer profile data structure is updated based on consumer activity data associated with the particular consumer. The particular incentive is transmitted to the particular consumer based on consumer data associated with the particular consumer, and the consumer profile data structure and the incentives offered data structure are updated based on receipt of an indication that the particular consumer redeemed the particular incentive.

### BRIEF DESCRIPTION OF THE DRAWINGS

FIG. 1 is a block diagram depicting a computer-implemented incentive management engine.

FIG. 2 is a block diagram depicting example data stored in a consumer profile data structure.

FIG. 3 is a block diagram depicting example data stored in an incentives offered data structure.

FIG. 4 is a block diagram depicting the capture of user activity data for updating of a consumer profile data structure.

FIG. 5 is a diagram depicting an example receipt that includes a QR code into which the transaction association code is embedded.

FIG. 6 depicts a user interface for an end user to enter a listing of products (e.g., foods) available, their costs, and rewards available for purchase of those products.

FIG. 7 depicts an example display provided to a particular consumer that provides a free sandwich to a particular consumer at one of a particular merchant's locations.

FIG. 8 is a block diagram depicting incentive transmission and tracking by an incentive management engine.

FIGS. 9-11 depict example interfaces that can be provided at a POS register to facilitate redemption of an incentive.

FIG. 12 is a flow diagram depicting a method of tracking effectiveness of incentives transmitted to particular customers.

### DETAILED DESCRIPTION

FIG. 1 is a block diagram depicting a computer-implemented incentive management engine. An incentive management engine 102 is configured to interact with one or more data stores 104 and one or more merchant systems, such as a point of sale register 106 and a merchant server 108 to track the effectiveness of incentives transmitted to particular consumers, such as through consumer mobile devices 110. In one example, the data store contains one or more data structures that include a consumer profile data structure 112 that is configured to store consumer data including consumer history data and an incentives offered data structure 114. The incentives offered data structure 114 is configured to store a history of incentives offered, including an identification of to which consumers a particular incentive was offered and which of those consumers redeemed the particular incentives. The incentive management engine 102, using one or more data processors, is configured to perform operations that include updating the consumer profile data structure 112 based on activity data associated with a particular consumer (e.g., purchases by the particular consumer, attendance of an event by the particular consumer), transmitting a particular incentive to the particular consumer based on consumer data associated with the particular consumer (e.g., providing the consumer a coupon for a caramel latte based on previous caramel latte purchases), and updating the consumer profile data structure 112 and the incentives offered data structure 114 based on receipt of an indication that the particular consumer redeemed the particular incentive.

The incentive management engine 102 can provide a mobile device-based customer loyalty program, advertising, mobile coupon, and commerce network that is designed to seamlessly integrate into merchant point-of-sale (POS) systems 106, e-commerce platforms, payment processing devices, and near-field communication (NFC) terminals. An incentive management engine 102 can enable a merchant, brand, organization, or product to create an integrated customer loyalty, mobile coupon, and advertising network. Incentive management engine campaigns can be updated and adjusted in real time to reflect reward venue capacity, inventory levels, desired day parts, selected menu item purchase, geo-location parameters, as well as other parameters.

An incentive management engine can be used to track, reward, and incentivize engagement with other non-commerce related activities such as radio, television, web, social, print, or omnichannel engagement. One purpose of being able to track engagement across these channels is to ultimately understand an individual user's “taste graph” and measuring true ROI mechanics behind each respective channel. This technology can be used to derive metrics around whether a unique advertisement has actually resulted in engagement and/or a chance in consumer behavior, such as making an additional visit or purchase. Ultimately, this can be used to further refine the specificity in which all advertisements can be created in the future to return the most actual revenue to the merchant or other user of the incentive management engine 102.

By continually collecting item-level transaction histories for each consumer across a network of merchants/brands, an incentive management engine 102 can build a unique taste graph for each individual consumer. In doing so, an incentive management engine can accurately determine what specific items/merchants/brands a consumer is likely to purchase in the future. Having this individualized data available, an incentive management engine 102 can construct automated advertising campaigns that are distributed to each unique individual based on their preference for items/brands/merchants/sizes/color preferences, and more. An incentive management engine is also able to more accurately present each consumer with future recommendations on products, merchants, brands, and activities that they are more likely to respond with desired action. These advertisements can be driven through any channel that chooses to gain access to this data in real time. For example, by connecting a consumer's incentive management engine account with their home entertainment system, more effective advertisements can be displayed for the consumer on their home television or radio. Each advertisement can be created based off of the consumer's unique purchase and engagement history of activity across the entire network.

An incentive management engine 102 can be used to provide dynamic, real-time, location-based, and user-specific advertisements, offers, promotions, and rewards. Such a rewarding and recommendation engine can be based on an individuals' personal demographic data, their device's physical geo-location, their historic item-level purchasing behaviors, collection of merchant enrollment, as well as other data. An incentive management engine can be utilized by merchants, retailers, e-commerce websites, brands, consumer package goods, venues, teams, organizations, and others.

FIG. 2 is a block diagram depicting example data stored in a consumer profile data structure. A consumer profile data structure 202 is stored on one or more computer-readable mediums as part of a data store 204. A consumer profile data structure 202 is configured to store consumer data, which can include consumer history data. In the example of FIG. 2, the consumer profile data structure 202 contains consumer bibliographic data such as a user identification index, a user name, and a user address. The consumer profile data structure 202 further includes a record of purchases for the user at merchant A, coupons or offers redeemed, as well as a number of loyalty points earned at merchant A. The consumer profile data structure 202 also includes records of purchases at other merchants, such as Merchant B, as well as a record of Merchant B activities in which the consumer has participated.

FIG. 3 is a block diagram depicting example data stored in an incentives offered data structure. An incentives offered data structure 302 is stored on one or more computer-readable mediums as part of a data store 304. An incentives offered data structure 302 is configured to store a history of incentives offered including an identification of to which consumers a particular incentive was offered and which of those consumers redeemed the particular incentives. In the example of FIG. 3, the incentives offered data structure 302 tracks, for a particular incentive, incentive bibliographic data, such as an incentive identification index, an identification of a merchant associated with the incentive, and details of the incentive (e.g., a percentage off purchased over $X; a percentage off any purchase; $X off purchase over $Y; a free product). The incentives offered data structure 302 further tracks user indexes of consumers the incentive was offered to and indexes of which consumers have redeemed the incentive.

An incentive management engine is configured to perform a variety of actions including tracking of user activity data. FIG. 4 is a block diagram depicting the capture of user activity data for updating of a consumer profile data structure. The incentive management engine 402 interacts with external hardware, such as POS merchant devices 404 and servers 406 and consumer devices 408, such as consumer mobile devices, to capture user activity data that is incorporated into a consumer profile data structure 410 stored in a data store 412. The incentive management engine 402 can capture user activity data in a variety of ways. In one example, a merchant POS register 404 is running software configured to communicate with the incentive management engine 402 via a network. The POS register 404 transmits user activity data, such as a list of items purchased by a consumer to the incentive management engine 402. If the incentive management engine 402 has enough data to associate that activity data from the POS register 404 to identify a particular consumer associated with that transaction, then the incentive management engine 402 updates that particular consumer's record(s) in the consumer profile data structure 410 accordingly. For example, if the incentive management engine can identify the particular consumer based on a name and partial credit card number provided from the POS register, then the consumer profile data structure 410 can be updated without further steps.

In another example, the particular consumer takes additional action to associate the purchase activity with his account. The particular consumer can be enticed to take these additional actions, such as through the rewarding of loyalty points or other rewards. In one example, the POS register 404 provides the transaction details (e.g., a list of products purchased and a price for each product purchased) to the incentive management engine 402. The incentive management engine 402 associates a code with that transaction and stores the transaction details along with the code. The code is provided to the POS register, which provides the code 414 to the particular consumer. The code 414 can be provided to the particular consumer in a variety of ways. For example, the code can be provided to the particular consumer on a purchase receipt associated with the transaction. FIG. 5 is a diagram depicting an example receipt that includes a QR code into which the transaction association code 414 is embedded. The particular consumer can use their consumer device 408 (e.g., a mobile computing device, a desktop computer) to capture the code, such as via a camera or scanner. In other examples, the code is captured by the consumer device 408 using other mechanisms, such as via a bar code that is scanned, an alpha-numeric code that is entered by a keyboard, or via short range proximity communication between the POS register 404 and the consumer device 408. The consumer device 408 associates the transaction code 414 with the particular consumer, such as via an application running on the consumer device, and the consumer device 408 communicates the transaction code 414 and an identification of the particular consumer to the incentive management engine, which updates the consumer profile data structure 410 accordingly.

Codes can be provided to a consumer in a variety of other scenarios and using other mechanisms as well. For example, a consumer could be provided a code for attendance at an event (e.g., a keyword to enter that is valid for a limited period of time or at a limited location associated with the event), participation in an activity (e.g., a paper depicting a code is provided to the particular consumer or posted at an event), or a particular code is provided via another medium such as during a broadcast of a radio or television program or commercial, in store signage, or newspaper.

An incentive management engine can be configured to limit an amount of consumer activity data to capture and associate with a particular user. Such limits may be desirable in a variety of contexts including for preventing abuse and to enforce rules of a program. In one example, consumer activity tracking and rewarding can be limited based on geographic location. In one example certain keywords, barcodes, and near field communications device codes require location-specific parameters to be met for crediting activity to a consumer. Such limitations can provide accurate representations of a user's physical location when actions (e.g., entry of a code into a consumer mobile device) are performed. In another example, time limitations can be enforced. For example, codes can be activated and deactivated based on the current time. For example, a code could be activated for as little as a minute if the associated program so required. When a consumer attempts to enter a code outside of a valid time period, an indication of such can be provided to the consumer, such as via a user interface of a mobile device of the consumer. In a further example, frequency limitations can be enforced. In one example, an engagement limit as a whole (e.g., 100 engagements total for all consumers) or for each individual user (e.g., each user can only engage with each input method once) is applied. By doing so, an end user can create usage scenarios in which codes can be live within public environments with limited exposure to abuse or overexposure of programs, campaigns, or sweepstakes. This feature can be enabled/disabled in real time to change frequency limits without needing to physically change the displayed code itself. In a further example, age restrictions can be applied, such as in campaigns involving adult content displayed in public (e.g., alcohol or tobacco references).

An incentive management engine can interact with code level integrations with POS systems to enable integration and activation into a merchant or other user's location or site. By integrating into an existing POS system, a need for additional hardware to support or execute a system for offering and tracking incentives can be avoided. In one example, an incentive management engine 402 creates an account and program with/for each end user customer (e.g., merchant), and incentive management engine software is physically installed into the merchant system. The program can then begin operation. With the program installed, each new transaction can be physically printed with a unique barcode that lives on the trailer of the receipt, such as the receipt depicted in FIG. 5. This barcode is generated through the software integration with the incentive management engine. Prior to the transaction receipt being printed, the POS system 404 sends all transaction check detail to the incentive management engine 402, which may operate on cloud-based server. Once the information is sent to the server, the check detail is instantly analyzed against the current incentive program structure that this specific merchant account is running at that exact time. Once analyzed, the incentive management engine 402 determines what content to return back to the POS system 404 for printing. This can include reward points, coupons, discounts, game entries, and more. The incentive management engine 402 then sends this unique string of encrypted data back to the point of sale system 404. Once received by the POS register 404, the register 404 then prints the check receipt with the code (e.g., bar code, QR code) with instructions, such as “Scan this code to collect reward points and coupons based on today's purchase.” Once properly installed at the end user's hardware 404, 406, the incentive program can run and collect consumer data, allow redemption of incentives, and track redemption of incentives.

A merchant or other end user of the incentive management engine 402 can tailor a reward program to meet their needs and revise such program based on incentive success metrics. For example, a merchant may design a program where loyalty points are provided by the consumer based on purchases of any items, purchases of certain items, or purchase amounts. FIG. 6 depicts a user interface for an end user to enter a listing of products (e.g., foods) available, their costs, and rewards available for purchase of those products. Merchants may further design hybrid plans where loyalty points or other benefits are also earned for participation in activities (e.g., attending a sporting event, listening to a radio program, taking a test drive of a car).

Based on one of a number of configurable criteria, as discussed further herein, a consumer can be provided an incentive to perform an action. For example, a consumer can be provided a redemption code via an application running on a mobile device, a text message, an email, conventional mail, paper delivery, or otherwise that can be provided to a merchant to receive a reward such as a discount, free product, or other benefit. In one example, a consumer is mailed a paper that includes a barcode for reward redemption upon accumulation of a number of reward points. In another example, a user can select activation of an incentive reward in exchange for redemption of a number of loyalty points. In a further example, a user is provided an incentive on their mobile device based on an advertising campaign initiated by a merchant (e.g., provide all consumers who have made purchases in the last seven days with a redemption code for a free hot chocolate to entice another visit).

FIG. 7 depicts an example display provided to a particular consumer that provides a free sandwich to a particular consumer at one of a particular merchant's locations. The redemption code (“FY32B”) can be specific to the particular consumer, at a particular merchant, for a particular offer, so that when the particular consumer redeems the incentive by providing the code for entry at a merchant POS device, that redemption can be associated with the consumer by an incentive management engine such that an incentives offered data structure can be updated accordingly.

FIG. 8 is a block diagram depicting incentive transmission and tracking by an incentive management engine. A particular consumer is provided a redemption code 802. For example, the particular consumer may be provided the redemption code 802 via an application operating on a mobile consumer device 804 belonging to the particular consumer based on a command transmitted by an incentive management engine 806. For example, a merchant may request that an incentive for 10% off purchases of over $50 be provided to all consumers whose current location, as tracked by their consumer mobile devices 804, is within three miles of a merchant location. The redemption code 802 is can be displayed on a user interface of the consumer device 804 as an alpha-numeric code that can be provided to the merchant for entry in a POS register 808 or a barcode or QR code that can be scanned by the POS register 808. In other examples, the redemption code 802 can be provided orally by the particular consumer to a merchant or the redemption code can be displayed via a physical medium such as a paper mailed to the particular consumer or included with a product (e.g., in a cereal box) containing a barcode, QR code, or alpha-numeric code.

When the particular consumer attempts to redeem an incentive, such as through providing a redemption code 802, the incentive management engine 806 may interact with the merchant POS register 808 to validate the redemption and properly apply the incentive. In one example, the POS register transmits the redemption code provided by the particular consumer to the incentive management engine 806. The incentive management engine 806 performs a series of checks to determine whether the redemption code is valid an applicable. For example, the incentive management engine 806 may check to see if the redemption code 802 is a valid incentive code for the incentive management system 806, if valid, to see if the redemption code 802 is currently active and not expired, if valid, to see if the redemption code 802 is usable at the particular merchant and/or location, if valid, to see if the incentive qualifies to be applied to the selected transaction (e.g., a 10% off purchases over $50 incentive is not valid for a transaction indicating a purchase of $35), if valid, to see if the incentive is valid for the particular consumer identity. If the redemption code 802 is determined to be valid, then the incentive management engine 806 instructs the POS register 808 to apply the appropriate discount based on the redemption parameters previously identified by the end user (e.g., merchant). In addition, the incentive management engine 806 tracks the redemption of the incentive by the particular user, such as by updating the incentives offered data structure 810 to indicate that the particular consumer redeemed the incentive. Further, the incentive management engine 806 may update the consumer profile data structure 812 to reflect details of the transaction (e.g., products purchased in addition to the incentive redemption). In instances where the redemption code 802 is deemed invalid, a response indicating such is returned to the POS register 808.

FIGS. 9-11 depict example interfaces that can be provided at a POS register to facilitate redemption of an incentive. FIG. 9 depicts a POS register user interface for a restaurant, where a member of the wait-staff has selected an incentive redemption interface control. The user interface displays a number of types of incentives that can be redeemed, including a “LoyalTree” incentive that is associated with an incentive management engine. Upon selection of the LoyalTree incentive, the interface in FIG. 10 is displayed, where the wait-staff member can enter a redemption code via a keyboard interface. In other examples, a barcode/QR scanner, a near-field device, or other mechanism connected to the POS register can be utilized to access the redemption code from the particular consumer (e.g., off the screen of a consumer mobile device, off of a piece of paper provided to the particular consumer).

Upon entry of the redemption code, the POS register transmits the code to an incentive management engine for verification, such as over a network. If the incentive management engine deems the redemption code to be valid, then the incentive management engine will instruct the POS register to apply an appropriate discount that is associated with the redemption code. FIG. 11 depicts a user interface provided to the wait-staff member after application of a 10% discount to all items purchased in the transaction after the incentive management engine verifies the code entered in FIG. 10 and has instructed the POS register as to the proper discount to be applied. In other examples, incentives can be redeemed and tracked via Internet websites, such as through the use of webpage redemption widgets.

An incentive management engine can also be used to provide detailed reports on data tracked, such as data from a consumer profile data structure and an incentives offered data structure, providing highly detailed analytics on consumer behavior and incentive effectiveness. Such reports can be used to report on trends in user behavior and engagement, effectiveness of advertising and incentive campaigns, and to more effectively tailor future advertising and incentive campaigns.

An end user, such as a merchant, can set up an incentive program to be run using an incentive management engine according to a variety of frameworks. In one example, a program can be based at least in part on currency spent. An incentive management engine program can be composed to reward users, or unlock content, when a user has physically spent a predetermined amount of money with/at/on that merchant's location or products. A program can also be based at least in part on frequency of consumer activity. For example, an incentive management engine program can be composed to reward consumers, or unlock content, when a user has physically participated in required tasks or activities a predetermined number of times in a predetermined period. Frequency can be based off of activities, physical visits, purchases within a period, or other factors. In another example, an incentive management program can include bonuses, multiplier items, or multiplier tasks. An incentive management engine program can be composed to reward consumers, or unlock content, when a consumer has purchased a selected specific menu/inventory items. This can be used to reward consumers exclusively for buying or interacting with predetermined items or activities of importance. In a further example, a program can be based, at least in part, on historic performance. In such an example, a program can be structured to reward a user with an “intelligent discount, item, or coupon” based off of their own personal historic purchasing behaviors with that unique merchant or at any other tracked merchant. By designing such a program, a consumer can be rewarded with an item or discount that can create a higher level of response rate and specificity (e.g., if one knows that the consumer likes cheeseburgers based on prior purchases, it may not make sense to reward the consumer with a salad). In an additional example, a program can be based on a reward bank where consumers can “bank” reward points (as opposed to automatic unlocking of rewards) to save up for a predetermined list of prizes/discounts/coupons set forth by each end user (e.g., merchant).

An incentive management engine program can also be configured to automatically send rewards or incentives without manual intervention based on certain triggers (e.g., birthday coupons redeemable on a birthday or birthday month, an anniversary of the consumer joining a rewards program, a spend threshold, an engagement threshold such as a number of visits to a store, random selection such as in a contest). In one example, a reward or incentive can be sent based on a frequency or infrequency threshold, where the incentive management engine can send an automated incentive to a consumer based on predetermined periods of activity or inactivity (e.g., a discount is sent to every user in real-time that has not engaged with a business in 60 days to entice a new transaction.) In another example, a reward or incentive can be sent based on a location of a consumer, as identified by a mobile device of the consumer (e.g., an automated incentive can be distributed to consumers entering a predetermined geo-fence (location radius) of a merchant associated with the incentive management engine).

An incentive management program can also be created for sports teams or organizations, venues (e.g., stadium, concert halls, arenas, theaters). To do so, an incentive management engine can utilize the similar POS system level integrations to reward patrons based on their specific buying behaviors. In addition, an incentive management engine can reward consumers for physically attending an event through integrations with ticketing systems. To do so, an incentive management engine can establish predetermined values for each ticket or other proof of purchase and use either the ticket's unique ID that can physically be scanned or entered to an incentive management engine enabled mobile application to reward credit, points, and more for a user on a pre-established program. In addition to just ticket and purchase-level rewards, an incentive management engine can track, correlate, and measure engagement across a multitude of marketing channels. For example, to incentivize a patron to visit a merchant's website, an incentive management engine widget can be embedded into this site to display unique content that would unlock predetermined value to the consumer. This also can apply to all other marketing mediums as well.

An incentive management engine sports and entertainment program gives the end user organization the ability to measure exactly who is in attendance, their historic interactivity with the organization, total lifetime value for the brand, potential future value, top items, day parts, and more that drive their engagement. By being able to measure a correlate data across nearly every channel in which an organization has a presence, the organization is able to determine accurate ROI for each of these channels. This data also can be used to power future marketing campaigns, CRM engagement, advertisements, promotions of upcoming events, and more. (e.g., by understanding that a unique member has a certain preference in live concert type, an incentive management engine can help with accurate identification of likely members of a consumer population to target with advertisements, promotions and more.)

An incentive management engine can also be configured to create and manage location-based scavenger hunts, games, maps, and more. By engaging with an incentive management engine, a mobile device can 1) look to see if the device is within a predetermined geo-fence 2) if so, provide a return piece of information (clue, discount, prize, incentive, etc). Such mechanisms can be used for physical discovery of a venue, location, item, or activity. Promotions, sweepstakes, contests and more can use the same technology to reward and track participation (e.g., each participation event can reward a consumer based on their history, randomness, or other factors).

An incentive management engine can be deployed on consumer devices (e.g., a consumer smart phone or tablet device) using a variety of models. A first model utilizes an incentive management engine mobile application. Such a model can be a stand-alone product that aggregates all merchant accounts currently available for a particular consumer's participation into a single mobile device application (“app”). A second method is through a white label solution. By creating a white label mobile application, an incentive management engine can deliver features to an app that is specifically devoted to an individual end user (e.g., a particular merchant or organization). A further deployment scheme enables access to an incentive management engine via API connectivity. In such an implementation, a third party mobile application can develop API connectivity with the incentive management engine and allow a user to have access to that specific merchant's incentive management engine program. Such a configuration would enable integration of an incentive management engine program into an existing application.

FIG. 12 is a flow diagram depicting a method of tracking effectiveness of incentives transmitted to particular customers. At 1202, a consumer profile data structure configured to store consumer data including consumer history data is maintained. At 1204, an incentives offered data structure is maintained that is configured to store a history of incentives offered including an identification of to which consumers a particular incentive was offered and which of those consumers redeemed the particular incentive. The consumer profile data structure is updated at 1206 based on consumer activity data associated with the particular consumer. At 1208, the particular incentive is transmitted to the particular consumer based on consumer data associated with the particular consumer, and at 1210, the consumer profile data structure and the incentives offered data structure are updated based on receipt of an indication that the particular consumer redeemed the particular incentive.

This application uses examples to illustrate the invention. The patentable scope of the invention includes other examples.

It is claimed:

1. A processor-implemented system for tracking effectiveness of incentives transmitted to particular consumers, comprising:
one or more computer-readable mediums configured to store one or more data structures including:
a consumer profile data structure configured to store consumer data including consumer history data;
an incentives offered data structure configured to store a history of incentives offered including an identification of to which consumers a particular incentive was offered and which of those consumers redeemed the particular incentive;
one or more data processors configured to access the one or more computer-readable mediums and to execute steps including:
updating the consumer profile data structure based on consumer activity data associated with the particular consumer;
transmitting the particular incentive to the particular consumer based on consumer data associated with the particular consumer; and
updating the consumer profile data structure and the incentives offered data structure based on receipt of an indication that the particular consumer redeemed the particular incentive.

2. The system of claim 1, wherein the consumer activity data is received from an application operating on a mobile device of the particular consumer.

3. The system of claim 2, wherein the consumer activity data is received from the mobile device based on the particular consumer entering a code into the mobile device.

4. The system of claim 3, wherein the code is entered via typing on a keypad, scanning a barcode, scanning a QR code or bringing the mobile device within a threshold proximity of a transmitter.

5. The system of 3, wherein the code is generated based on an action of the particular consumer.

6. The system of claim 5, wherein the code is generated based on a purchase of the particular consumer.

7. The system of claim 3, wherein the code is provided to the particular consumer on a receipt for a consumer action.

8. The system of claim 7, wherein the steps performed by the one or more data processors further include:
receiving an indication of consumer action from a merchant;
generating the code based on the indication;
transmitting the code to the merchant, wherein the code is printed on the receipt.

9. The system of claim 8, wherein the steps performed by the one or more data processors further include:
storing the indication of consumer action in the one or more computer-readable mediums;
wherein, when the consumer activity data is received from the mobile device based on the particular consumer entering the code, associating the consumer action with the particular consumer and updating the consumer profile data structure based on the consumer action by the particular consumer.

10. The system of claim 8, wherein the indication of consumer action is received from a merchant point of sale device.

11. The system of claim 1, wherein the particular incentive is transmitted to the particular consumer for display on a mobile device of the particular consumer.

12. The system of claim 11, wherein the particular incentive includes display of a redemption code, a redemption barcode, or a redemption QR code.

13. The system of claim 12, wherein the indication that the particular consumer redeemed the particular incentive is received from a merchant.

14. The system of claim 13, wherein the steps performed by the one or more data processors further include providing a validation of an attempt by the particular consumer to redeem the particular incentive with the merchant.

15. The system of claim 14, wherein the validation includes:
determining that the code, barcode, or QR code is associated with the particular incentive;
determining that the particular incentive is unexpired;
determining that the particular incentive is associated with the merchant;
determining that the particular consumer has performed any required actions for the particular incentive; and
sending a validation signal to the merchant.

16. The system of claim 1, wherein the particular incentive is transmitted to the particular consumer based on past purchase history of the particular consumer.

17. The system of claim 1, wherein the particular incentive is transmitted to the particular consumer based on acquisition of loyalty points, tracked by the consumer profile data structure, by the particular consumer.

18. The system of claim 17, wherein loyalty points are credited to the particular consumer based on purchases, participation in activities, actions performed, or attendance at events.

19. The system of claim 1, wherein the particular incentive offers a free item, a percentage discount, or a particular discount amount to the particular consumer.

20. The system of claim 1, wherein the particular incentive is offered for an item that the particular consumer has previously purchased to entice a subsequent purchase, or wherein the particular incentive is offered for an item that the particular consumer has never purchased to encourage a change in behavior for the particular consumer.

21. The system of claim 1, wherein the particular incentive is transmitted to the particular consumer based on a lack of activity by the particular consumer over a particular time period.

22. The system of claim 1, wherein the particular incentive is transmitted to the particular consumer based on the particular consumer being within a particular geographic area.

23. The system of claim 1, wherein the steps performed by the one or more data processors include:
providing a report on activity of the particular consumer using the consumer profile data structure; and
providing a report on effectiveness of the particular incentive using the incentives offered data structure.

24. A computer-implemented method of tracking effectiveness of incentives transmitted to particular customers, comprising:
maintaining a consumer profile data structure configured to store consumer data including consumer history data;
maintaining an incentives offered data structure configured to store a history of incentives offered including an identification of to which consumers a particular incentive was offered and which of those consumers redeemed the particular incentive;
updating the consumer profile data structure based on consumer activity data associated with the particular consumer;
transmitting the particular incentive to the particular consumer based on consumer data associated with the particular consumer; and
updating the consumer profile data structure and the incentives offered data structure based on receipt of an indication that the particular consumer redeemed the particular incentive.
